(19) United States
(12) Patent Application Publication
(10) Pub. No.: US 2007/0093326 A1
(43) Pub. Date: Apr. 26, 2007

(54) Power transmission device

(75) Inventor: Michiyasu Nosaka, Anjo-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/583,008

(22) Filed: Oct. 19, 2006

(30) Foreign Application Priority Data
Oct. 24, 2005 (JP) 2005-308566

(51) Int. Cl. F16H 61/00; F16H 59/00

(52) U.S. Cl. 474/70

(57) ABSTRACT

A power transmission device (10) comprises a rotatable rotary part (1) to which a rotatable drive force is transmitted from a drive source and a connection part (2, 3) that connects to the rotary part on one hand, and connecting to a rotating shaft (4) of a device to be driven on the other hand. The rotary part comprises a first concave/convex part (101) arranged in the circumferential direction and the connection part comprises a second concave/convex part (201) arranged in the circumferential direction. The rotary part and the connection part are connected to each other by the insertion of the first concave/convex part and the second concave/convex part into each other. The second concave/convex part is formed by a material having elasticity. Further, in the second concave/convex part, holes or cavities (201a, 201b, 201c) are formed.

### BACKGROUND OF THE INVENTION

1. Field of the Invention

The present invention relates to a power transmission device and, more particularly, is preferably used in a compressor for a vehicle air conditioner operated by an external power source, such as an engine and via a belt etc., by being incorporated therein.

2. Description of the Related Art

A refrigerant compressor for a vehicle air conditioner is driven by an external power source, such as an engine and via a belt, pulley, etc., and an electromagnetic clutch may be inserted therebetween in order to disconnect the engine and the compressor. If, however, an electromagnetic clutch is not inserted, the cost is reduced and, in some cases, an electromagnetic clutch may be omitted. In this case, as a power transmission device of a compressor for a vehicle air conditioner operated by an external power source such as an engine via a belt etc., a power transmission device having a torque limiter (power transmission shut-off member) is frequently used in order to avoid a problem, such as belt damage, if the compressor seizes.

Such power transmission devices include one in which a part of the power transmission path is threadedly joined to utilize an excessive axial force generated at the threadedly joined part due to an excessive torque when the compressor seizes as a torque limiter (for example, refer to patent document 1). As described above, in a conventional power transmission device for transmitting power to a compressor, a power transmission shut-off device (torque limiter) is arranged in order to avoid a problem, such as damage to a belt for power transmission, if the compressor seizes. A torque limiter type power transmission device has a function to cut off the power transmission path by rupturing a part of the power transmission shut-off member using the excessive torque generated when the compressor seizes.

On the other hand, a compressor for a vehicle air conditioner operated by an external power source, such as an engine, via a belt etc. produces vibration and noise due to torque variation. In some case, such vibration may loosen a portion fastened by a bolt etc. or may apply repetitive stress to associated devices. Further, vibration and noise adversely affect the surrounding environment or the working environment. Specifically, in the case of a compressor for a vehicle air conditioner, such vibration and noise give an unpleasant feeling to a passenger.

It is possible to cause a power transmission device to have the function of damping vibration and noise to a certain level by an adequate arrangement of the structure. FIG. 17 shows an example of a conventional power transmission device for transmitting power to a compressor. FIG. 17 is a front view of a power transmission device 50 in a conventional example. The power transmission device 50 in the conventional example has a structure, in which a pulley 1 comprises a concave/convex part 101, which is a concave/convex shaped insertion part and a hub 2 also comprises a concave/convex shaped concave/convex part 201 constituted by an elastic member, and the concave/convex parts 101, 201 are engaged with each other by inserting both the concave/convex parts 101 and 201 into each other in the axial direction and thus power is transmitted. The power transmission device 50 has a structure in which torque variation is damped by the damper action of a cylinder-shaped cylinder part 203 constituted mainly by an elastic member, however, there arises a problem that the damping characteristic is deteriorated if the torsional spring modulus of the cylinder part 203 is increased in order to improve the durability of the cylinder part 203. Further, there arises another problem that, if the torsional spring modulus is reduced in order to improve the damping characteristic, the torque variation durability of the cylinder part 203 is reduced and the cylinder part 203 may be destroyed.

[Patent document 1] Japanese Unexamined Patent Publication (Kokai) No. 2003-206950

As described above, when an attempt is made to improve the damping function of the power transmission device against vibration and noise, there is a problem that the durability is reduced and, therefore, it has not been possible to improve the damping function in the conventional power transmission device.

### SUMMARY OF THE INVENTION

The above-described circumstances being taken into account, the present invention has been developed and an object thereof is to provide a power transmission device having a damping mechanism with high damping performance to reduce vibration and noise due to torque variation etc. produced by a compressor.

In a first aspect of the present invention, in order to attain the above-described object, a power transmission device (10) comprises a rotatable rotary part (1) to which a rotational drive force is transmitted from a drive source and a connection part (2, 3) that connects to the rotary part on one hand, and connecting to a rotating shaft (4) of a device to be driven on the other hand. The rotary part comprises a first concave/convex part (101) arranged in the circumferential direction and the connection part comprises a second concave/convex part (201) arranged in the circumferential direction. The rotary part and the connection part are connected to each other by the insertion of the first concave/convex part and the second concave/convex part into each other. The second concave/convex part is formed by a material having elasticity. Further, in the second concave/convex part, at least a hole or at least a cavity (201a, 201b, 201c) is formed.

Due to the configuration described above, a power transmission device having a damping mechanism with high damping performance is provided by arranging holes or cavities in the elastic second concave/convex part to reduce the torsional spring modulus of the second concave/convex part and to reduce the total torsional spring modulus without losing durability considerably. Due to this, it is possible to effectively reduce vibration and noise due to torque variation produced by a compressor for a vehicle air conditioner operated by an external power source, such as an engine, via a belt etc.

In a second aspect of the present invention according to the first aspect, the connection part (2, 3) comprises a power transmission shut-off member (3) that shuts off transmission of an excessive torque between the rotary part and the rotating shaft (4) of the device to be driven and a hub (2) that connects to the rotary part, on one hand, and connects to the power transmission shut-off member, on the other hand, in the above-mentioned first aspect. The power transmission shut-off member (3) is coupled to the rotating shaft and is capable of rotating together with the rotating shaft as one body. The second concave/convex part (201) is provided to the hub.

According to the present aspect, the power transmission device has the power transmission shut-off function and when, for example, the device to be driven such as a compressor, etc., locks, related devices, such as a driving device, are prevented from being damaged due to the operation of the power transmission shut-off member.

In the third aspect of the present invention according to the second aspect, the hub further comprises a cylinder part (203) formed in the second concave/convex part so as to connect thereto as one body on the inner side in the radial direction. The cylinder part is formed by a material having elasticity.

According to the present aspect, the power transmission device has sufficient durability and the damping performance for vibration, etc. is improved.

In a fourth aspect of the present invention according to any one of the first to third aspects, the holes or cavities formed in the second concave/convex part penetrate the second concave/convex part.

According to the present aspect, because the holes or cavities formed in the second concave/convex part penetrate, additional functions, such as easy mountability of a part to prevent the connection part from dropping, can be expected.

In a fifth aspect of the present invention according to the fourth aspect, a coupling member (9) is inserted into the hole or cavity and the coupling member couples the rotary part and the second concave/convex part.

According to the present aspect, when the power transmission shut-off member operates etc., there is a possibility that the connection part constituted by an elastic member is destroyed and drops from the rotary part, however, it is possible to prevent the second concave/convex part from dropping by coupling the second concave/convex part to the rotary part using the coupling member.

In a sixth aspect of the present invention according to the fifth aspect, the coupling member couples the rotary part and the second concave/convex part even when the cylinder part ruptures.

According to the present aspect, as in the fifth aspect, it is possible to prevent the second concave/convex part from dropping even when the second concave/convex part ruptures because the coupling member couples the connection part to the rotary part without fail.

In a seventh aspect of the present invention according to the fourth aspect, an annular plate (9) is also provided. The plate is arranged on the side in opposition to the rotary part with the second concave/convex part sandwiched in between and an extension part (9a) that extends from the plate passes through the hole or cavity and connects to the rotary part.

According to the present aspect, as in the fifth aspect, another aspect capable of preventing the second concave/convex part from dropping by comprising the plate is disclosed.

In an eighth aspect of the present invention according to any one of the first to seventh aspects, connection is made to a compressor for a vehicle air conditioner as a device to be driven.

According to the present invention, an aspect that further clarifies the use of the present invention is disclosed.

The present invention may be more fully understood from the description of the preferred embodiments of the invention set forth below, together with the accompanying drawings.

### BRIEF DESCRIPTION OF THE DRAWINGS

In the drawings:

FIG. 1 is a diagrammatic front view of a power transmission device 10 according to a first embodiment of the present invention.

FIG. 2 is a side section view of FIG. 1.

FIG. 3 is an enlarged front view of a concave/convex part in FIG. 1.

FIG. 4 is a side view of FIG. 3.

FIG. 5 is a side section view of a power transmission device 11 in a second embodiment of the present invention, corresponding to FIG. 2.

FIG. 6 is a side section view of a power transmission device 12 in a third embodiment of the present invention, corresponding to FIG. 2.

FIG. 7 is a side view of an insertion part of a power transmission device 13 in a fourth embodiment of the present invention, corresponding to FIG. 4.

FIG. 8 is a side view of an insertion part of a power transmission device 14 in a fifth embodiment of the present invention, corresponding to FIG. 4.

FIG. 9 is a side view of an insertion part of a power transmission device 15 in a sixth embodiment of the present invention, corresponding to FIG. 4.

FIG. 10 is a partial front view of a power transmission device 16 in a seventh embodiment of the present invention, corresponding to FIG. 3.

FIG. 11 is a partial front view of a power transmission device 17 in an eighth embodiment of the present invention, corresponding to FIG. 3.

FIG. 12 is a side view of an insertion part of a power transmission device 18 in a ninth embodiment of the present invention, corresponding to FIG. 4.

FIG. 13 is a partial front view of a power transmission device 19 in a tenth embodiment of the present invention, corresponding to FIG. 3.

FIG. 14 is a side view when viewed from the arrow 14 in FIG. 13.

FIG. 15 is a diagrammatic front view of a power transmission device 20 according to an eleventh embodiment of the present invention.

FIG. 16 is a side section view of FIG. 15.

FIG. 17 is a diagrammatic front view of a conventional power transmission device 50.

### DESCRIPTION OF THE PREFERRED EMBODIMENTS

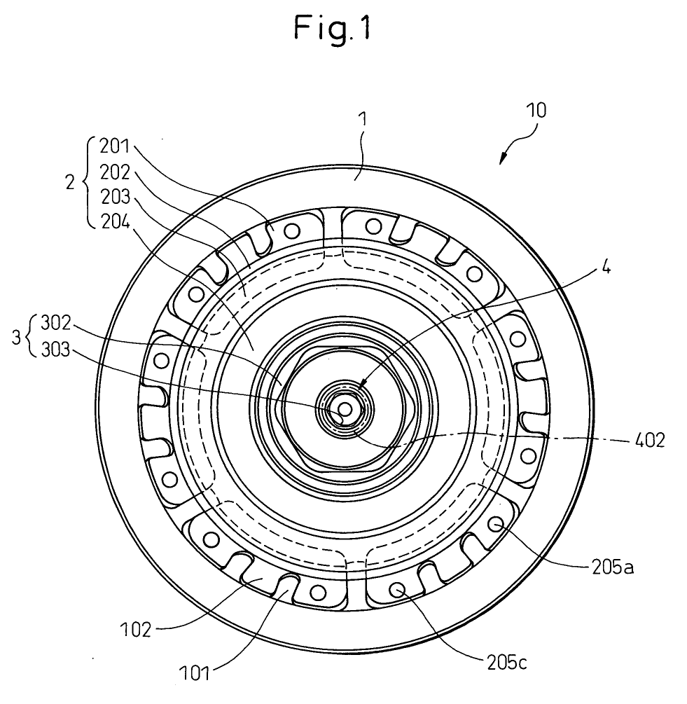

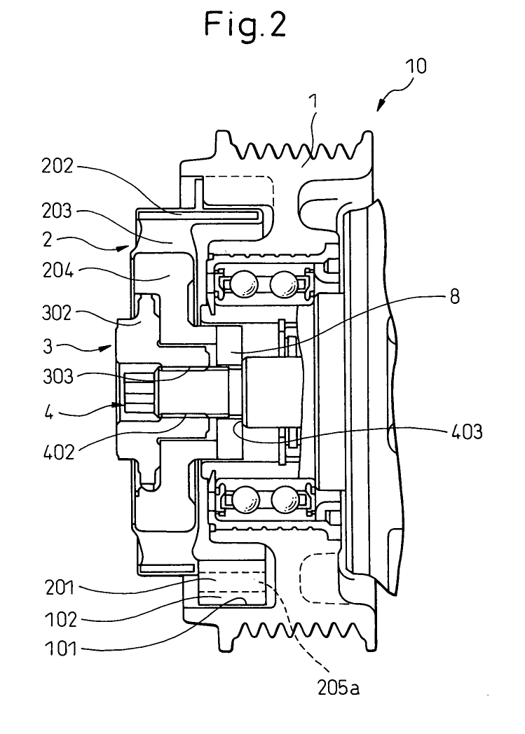

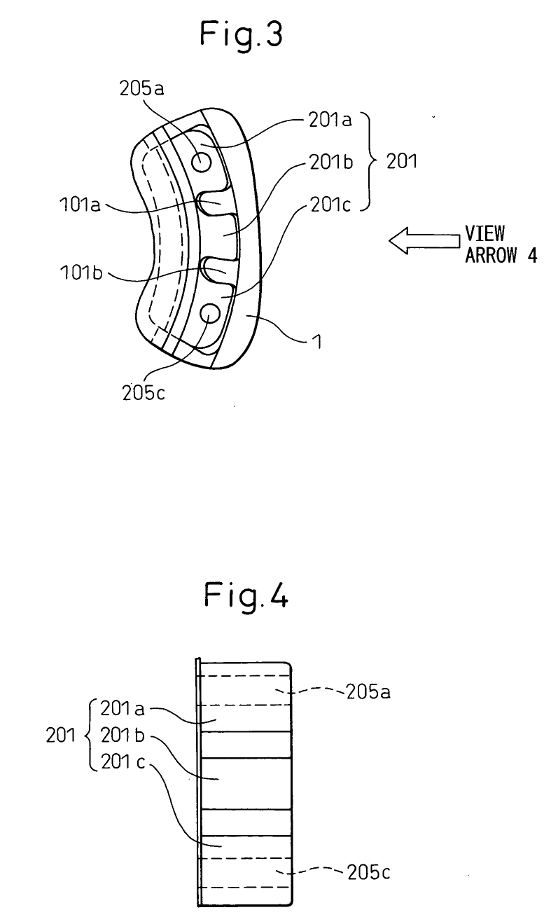

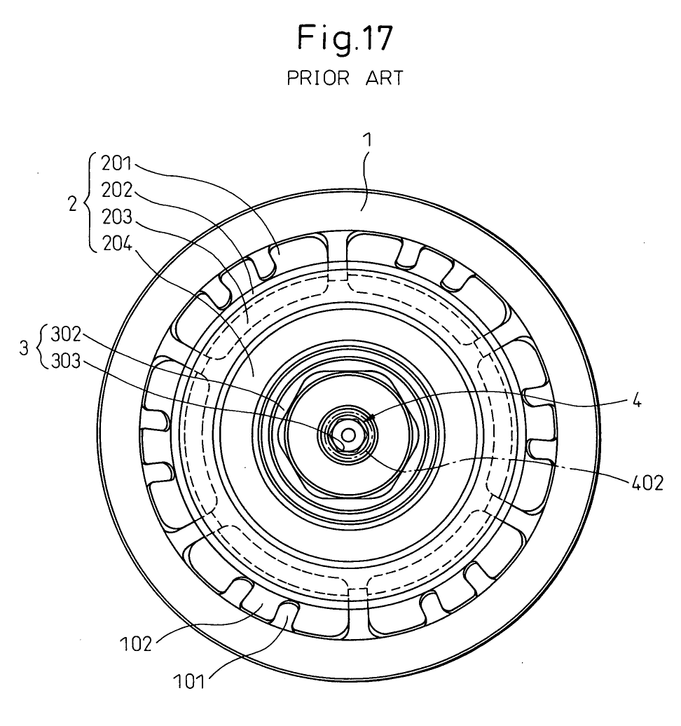

Embodiments of a power transmission device according to the present invention will be described below, in detail, based on the drawings. FIG. 1 shows a diagrammatic front view of a first embodiment of the power transmission device according to the present invention and FIG. 2 is a side section view of FIG. 1. FIG. 3 is an enlarged view of a concave/convex part in FIG. 1 and FIG. 4 is a side view when viewed from the arrow 4 in FIG. 3. The symbols of the components in FIG. 1 to FIG. 4 correspond to the symbols of the similar components in the conventional example of a power transmission device 50 in FIG. 17.

A power transmission device 10 in the first embodiment of the present invention shown in FIG. 1 is used, in an air conditioner for vehicle, as a device for transmitting a torque of an external drive source such as an engine to a compressor of a vehicle air conditioner, comprising a power transmission shut-off member (torque limiter) 3. In the power transmission device 10, rotational power from the outside is transmitted to a pulley 1 via a belt etc., not shown schematically, and transmitted to an inner hub 204 of a hub 2 by the insertion of a concave/convex part 201 (a second concave/convex part in claims), constituted by an elastic member installed on the outer periphery of the hub 2, into a concave/convex part 101 (a first concave/convex part in claims) of the pulley. As can be seen from FIG. 1, both the concave/convex part 101 of the pulley and the concave/convex part 201 of the hub form the concave/convex shape in the radial direction. The configuration of the pulley side concave/convex part 101 and the hub side concave/convex part 201 may be, for example, one in which a plurality of corresponding concave/convex parts are inserted into each other. Power is further transmitted from the hub 2 to the power transmission shut-off member 3 and in the present embodiment, the inner hub 204 and the power transmission shut-off member 3 are inserted into each other by a spigot insertion (insertion connection such as inserting a pipe into a socket) at the insertion part of the inner hub and the insertion part of the power transmission shut-off member. Here, the pulley 1 and the hub 2 correspond to the rotary part and the connection part in claims, respectively.

Torque transmission between the inner hub 204 and the power transmission shut-off member 3 may be performed by, for example, spigot insertion between the hexagonal insertion part, which is the outer periphery of a flange part 302 of the power transmission shut-off member 3, and the hexagonal insertion part of the hub 2 or by the caulked structure of a rotation stopper, as shown in FIG. 1. Alternatively, the torque may be transmitted by the spigot insertion with a shape other than a circle, such as a quadrangle, a width-across flat, a hexagon, an octagon, a decagon, or a dodecagon, or by the already known fastening means, such as the fastening by threads installed on the inner hub 204 and the power transmission shut-off member 3, although not shown schematically in the present embodiment. In FIG. 2, the inner hub 204 and the power transmission shut-off member 3 are fastened to each other by the axial force generated by the threaded coupling of a thread part 303 of the power transmission shut-off member and a thread part 402 of the rotating shaft 4 of the compressor. The load of the fastening in the axial direction is supported by a shaft contact surface 403 of the rotating shaft 4 via the inner hub 204 and a washer 8. The power transmitted from the hub 2 to the power transmission shut-off member 3 is transmitted from the power transmission shut-off member 3 to the rotating shaft 4 to rotationally drive the compressor, due to the frictional force by the threaded coupling of the power transmission shut-off member 3 and the compressor (not shown) as explained above. In the power transmission device 10 of the present embodiment, when an excessive torque occurs, the power transmission shut-off member 3 ruptures to prevent a belt etc. from being damaged.

In FIG. 1, power from the outside is transmitted to the pulley 1 via a belt, not shown, etc. and the power is transmitted to the inner hub 204 of the hub via the concave/convex part 201 constituted by an elastic member installed on the outer periphery of the hub 2 inserted into the concave/convex part 101 of the pulley. As shown in FIG. 1, both the concave/convex part 101 of the pulley and the concave/convex part 201 of the hub are formed so as to have a concave/convex shape in the radial direction, that is, in the direction perpendicular to the rotating shaft 4. On the inner side of the concave/convex part, an annular outer ring 202 is provided and between the outer ring 202 and the inner hub 204, a donut-shaped cylinder part 203 constituted by an elastic member is provided. The cylinder part 203 mainly functions as a damping mechanism and the above-mentioned outer peripheral concave/convex part 201 mainly functions to transmit power. The cylinder part 203 is a torque damping mechanism in which shearing force acts on the cylinder part 203 of the elastic member (this shearing force can be thought as tensional force on the cylinder part 203 because the cylinder part 203 is donut-shaped) and the above-mentioned concave/convex part 201 is a mechanism for power transmission in which the concave/convex part 201 of the elastic member is compressed, however, as the concave/convex part 201 of the elastic member is used under compression, and therefore, the concave/convex part 201 has the function of damping mechanism also. In other words, the structure shown in FIG. 1 and FIG. 2 is a hybrid damping mechanism of a torsional spring modulus k1 of the cylinder part 203 and a torsional spring modulus k2 of the outer peripheral concave/convex part 201 and a total torsional spring modulus K is obtained by the equation 1/K=1/k1+1/k2.

In the present embodiment, in the outer peripheral concave/convex part 201 of the hub in FIG. 1, holes “a” 205a and holes “c” 205c are provided to effect reduction in the above-mentioned torsional spring modulus k2. If k2 is reduced, the total torsional spring modulus K is also reduced and the damping characteristic improves. In other words, the natural frequency of the power transmission device is in proportion to the spring modulus and by reducing the natural frequency of the power transmission device with respect to a high frequency vibration-generating force, the damping characteristic improves. There is a method for reducing the total torsional spring modulus K by reducing the torsional spring modulus of the cylinder part 203, however, the cylinder part 203 is the damping mechanism used under shearing of the elastic member and, therefore, is inferior in durability compared to the outer peripheral concave/convex part 201. Therefore, the means to reduce the total torsional spring modulus K by reducing the torsional spring modulus of the outer peripheral concave/convex part 201 will provide a power transmission device having a damping mechanism without losing considerable durability.

As can be seen from FIG. 1, in the present embodiment, the insertion of the pulley 1 and the hub 2 is constituted by six sets of insertion parts. One set of the insertion parts is enlarged and shown in FIG. 1. As can be seen from the side section view in FIG. 2, on the pulley side, a pocket 102 is provided and the concave/convex part 201 of the hub 2 is inserted into the pocket 102 in the axial direction. The partial enlarged front view of this part is shown in FIG. 3. In the present embodiment, at the insertion part of the one set, the pulley side concave/convex part 101 comprises two protrusions 101a and 101b and the hub side concave/convex part comprises three protrusions 201a, 201b, and 201c, and they are inserted into each another as shown in FIG. 3.

It is preferable that the protrusions of the pulley side concave/convex part 101 have substantially the same width and height, however, the present invention is not limited to this. In the present embodiment, in the protrusions 201a and 201c at both the ends, among the three protrusions 201a, 201b, and 201c of the hub side concave/convex part 201, holes 205a and 205c are provided, respectively, so as to penetrate the concave/convex part 201 as shown in FIG. 3 and FIG. 4. However, the present invention is not limited to this. It is preferable that the width of the protrusion 201b at the center in which no hole is provided, among the three protrusions, be narrower than the widths of the protrusions 201a and 201c on both the ends as shown in FIG. 4, however, the present invention is not limited to this. In the present embodiment, the hole is provided in each of two protrusions at one set of insertion parts, however, the present invention is not limited to this and the hole may be provided in only one protrusion, or may be provided in each of the three protrusions. Further, the hole may be provided in only some of the six sets of insertion parts and there may be provided insertion parts in which no hole is provided.

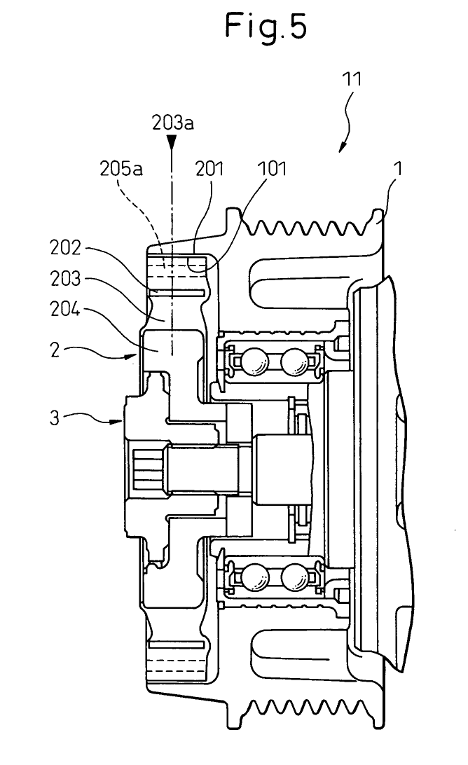

FIG. 5 is a side section view of a power transmission device 11 in a second embodiment of the present invention, corresponding to FIG. 2. In the above-mentioned first embodiment, as can be seen from FIG. 2, the hub side concave/convex part 201 is formed in such a manner that it is inserted into the pulley side pocket 102 and extends from the cylinder part 203 to be offset, however, in FIG. 5, in comparison to FIG. 2, the cylinder part 203 of the hub 2 and the concave/convex part 201 are not offset and are arranged on the same axis 203a. As configurations of the second embodiment other than those mentioned above are fundamentally the same as those in the first embodiment, an explanation is omitted.

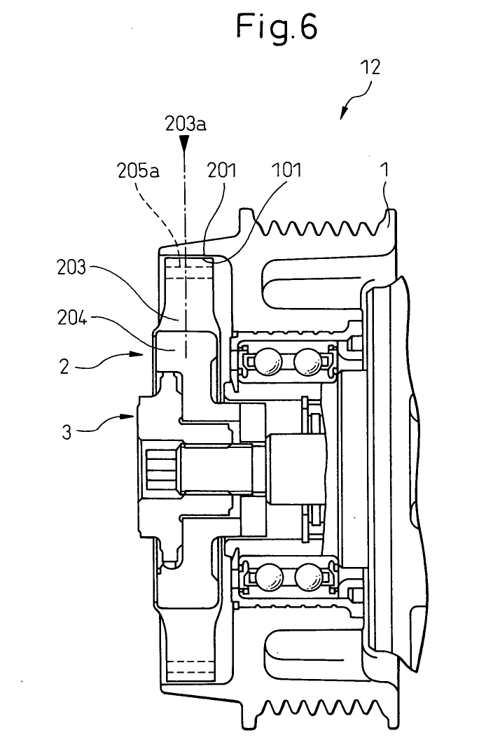

FIG. 6 is a side section view of a power transmission device 12 in a third embodiment of the present invention, corresponding to FIG. 5. As can be seen from the comparison with FIG. 5, the power transmission device 12 shown in FIG. 6 does not comprise the outer ring 202. As configurations of the third embodiment other than those mentioned above are fundamentally the same as those in the second embodiment, an explanation is omitted.

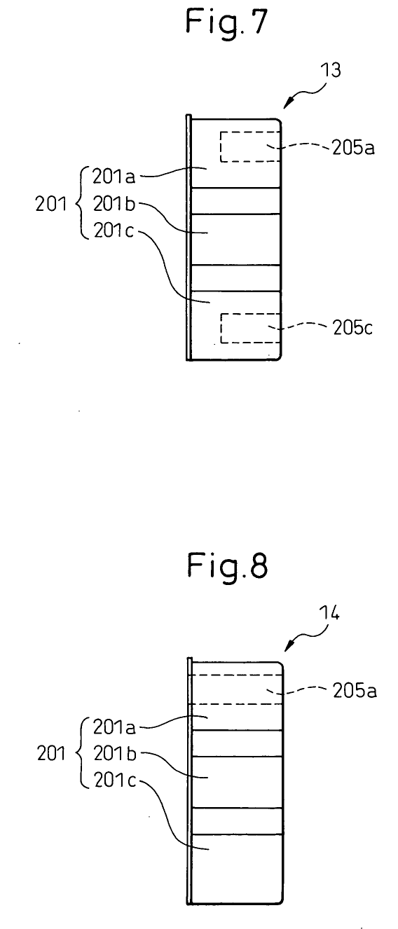

FIG. 7 is a side view of an insertion part of a power transmission device 13 in a fourth embodiment of the present invention, corresponding to FIG. 4. In the fourth embodiment shown in FIG. 7, the hole “a” 205a and the hole “c” 205c of the concave/convex part 201 do not penetrate the concave/convex part 201, but terminate in the concave/convex part 201. In this case, the torsional spring modulus is not reduced so much compared to the example shown in the first embodiment in FIG. 4 in which the hole penetrates through, however, compared to the conventional example, the spring modulus reduces considerably. As configurations of the fourth embodiment other than those mentioned above are fundamentally the same as those in the first embodiment, an explanation is omitted.

FIG. 8 is a side view of a power transmission device 14 in a fifth embodiment of the present invention, corresponding to FIG. 4. In the power transmission device 14 in FIG. 8, the hole “a” 205a is arranged only in the protrusion 201a of the concave/convex part. As configurations of the fifth embodiment other than those mentioned above are fundamentally the same as those in the first embodiment, an explanation is omitted.

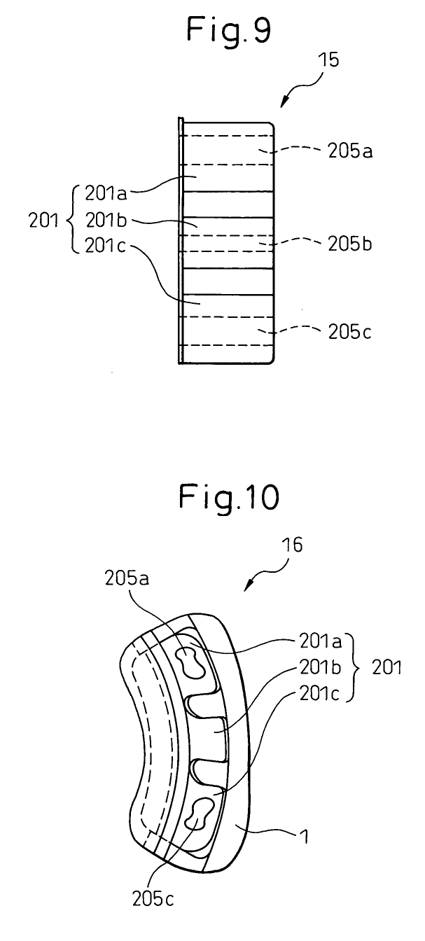

FIG. 9 is a side view of a power transmission device 15 in a sixth embodiment of the present invention, corresponding to FIG. 4. In the power transmission device 15 in FIG. 9, the holes 205a, 205b, and 205c are arranged in each of the protrusions 201a, 201b, and 201c of the concave/convex part 201. As configurations of the sixth embodiment other than those mentioned above are fundamentally the same as those in the first embodiment, an explanation is omitted.

FIG. 10 is a partial front view of a power transmission device 16 in a seventh embodiment of the present invention, corresponding to FIG. 3. In the power transmission device 16 in FIG. 10, the shape of the holes 205a and 205c provided in the protrusions of the concave/convex part 201 is not circular as the hole in the first embodiment, but a different shape such as the shape of a gourd. As described above, the shape of the hole is not limited to a circle but is arbitrary. As configurations of the seventh embodiment other than those mentioned above are fundamentally the same as those in the first embodiment, an explanation is omitted.

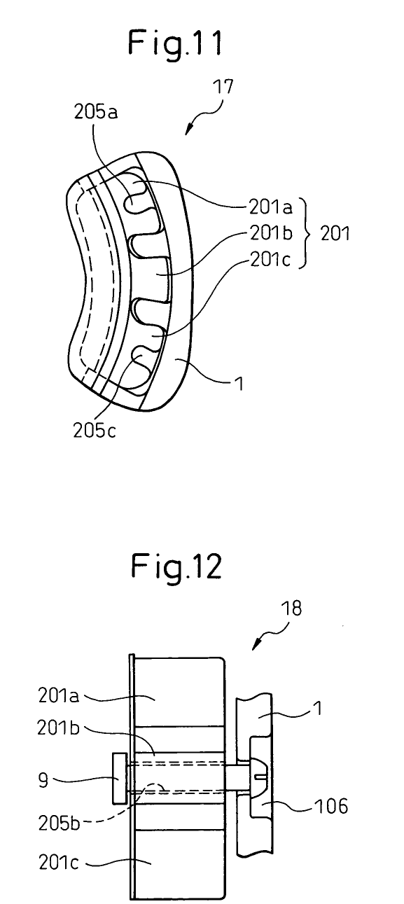

FIG. 11 is a partial front view of a power transmission device 17 in an eighth embodiment of the present invention, corresponding to FIG. 3. In the power transmission device 17 in FIG. 11, instead of holes, the cavities 205a and 205c are provided in the protrusions 201a and 201c of the hub side concave/convex part 201. The shape of the cavities 205a and 205c is one opening toward the outer peripheral side, as shown in FIG. 11. As configurations of the eighth embodiment other than those mentioned above are fundamentally the same as those in the first embodiment, an explanation is omitted.

FIG. 12 is a side view of a power transmission device 18 in a ninth embodiment of the present invention, corresponding to FIG. 4. In the power transmission device 18 in FIG. 12, the hole 205b is provided in the protrusion 201b of the concave/convex part 201 of the hub 2 and a pin 9 is inserted into the hole 205b. The concave/convex part 201 has a structure in which the concave/convex part 201 and the concave/convex part 101 of the pulley 1 are just inserted into each other in the axial direction, and therefore, when, for example, the power transmission shut-off member 3 operates, if the cylinder part 203 is destroyed, the concave/convex part 201 will drop from the pulley 1. In the present embodiment, the pin 9 has a large-diameter head portion on one of the end portions (on the left-hand side in the figure), as shown in FIG. 12, and therefore, the pin 9 is unlikely to pass through the hole 205b but come into contact with the side surface of the concave/convex part 201 of the hub 2 in such a manner as to be hooked thereon, and the other end portion penetrates through the hole provided in the pulley 1 and is caulked, etc., and thus the pulley 1 and the hub 2 are coupled to each other at the concave/convex part 201. In FIG. 12, the drop-preventing pin 9 is inserted into the hole 205 of the concave/convex part 201 and coupled to the pulley portion, thereby the concave/convex part 201 can be prevented from dropping. If the gap between the diameter of the drop-preventing pin 6 and the hole 205b is large, the torsional spring modulus of the concave/convex part 201 reduces and the damping characteristic improves. Even if a sufficiently large gap cannot be obtained, it is possible to prevent the concave/convex part 201 from dropping. As configurations of the ninth embodiment other than those mentioned above are fundamentally the same as those in the first embodiment, an explanation is omitted.

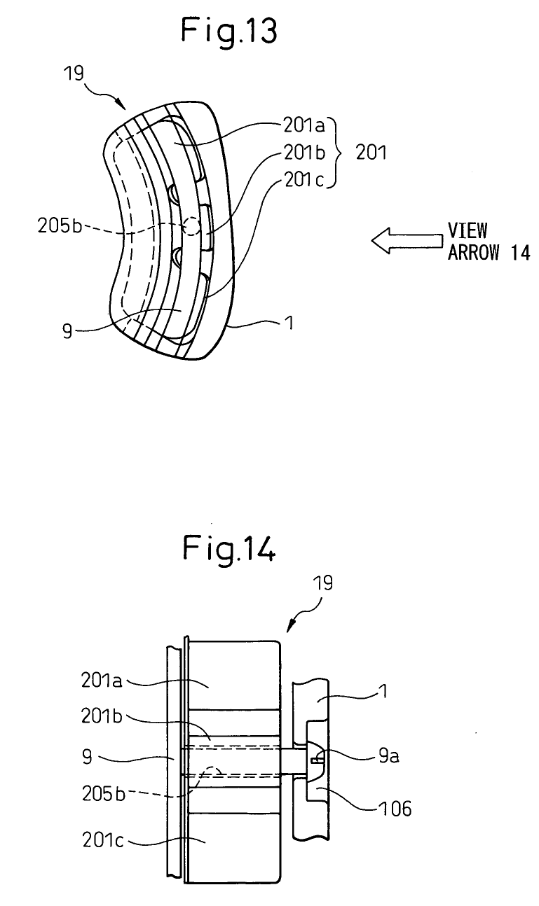

FIG. 13 is a partial front view of a power transmission device 19 in a tenth embodiment of the present invention, corresponding to FIG. 3 and FIG. 14 is a side view when FIG. 13 is viewed from the side surface (the view arrow 14). The power transmission device 19 in FIG. 13 is an example in which a retaining ring (9) is installed instead of the drop-preventing pin. In other words, the annular retaining ring 9 is provided at the location of the concave/convex part 201 and a retaining ring pin 9a extending from the retaining ring 9 penetrates the hole 205b and couples to the pulley 1, and therefore, the pulley 1 and the hub side concave/convex part 201 are coupled to each other. Due to this configuration, it is possible to prevent the concave/convex part 201 from dropping. As configurations of the tenth embodiment other than those mentioned above are fundamentally the same as those in the ninth embodiment, an explanation is omitted.

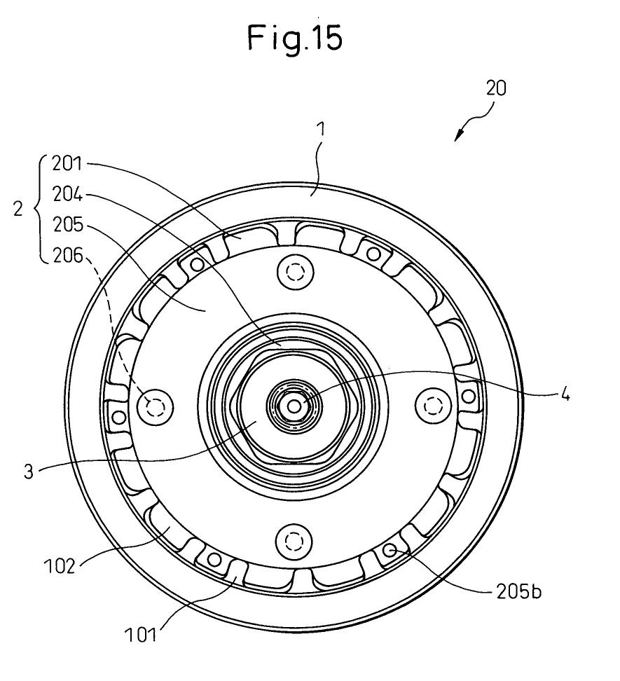

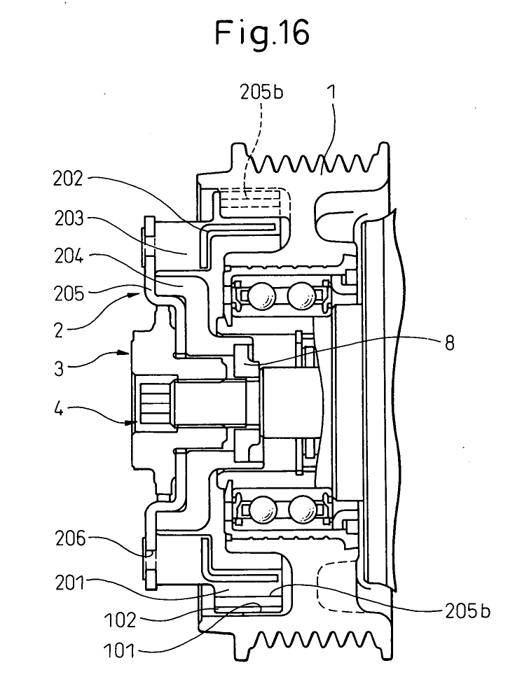

FIG. 15 is a front view of a power transmission device 20 in an eleventh embodiment of the present invention, corresponding to FIG. 1 and FIG. 16 is a side section view similar to FIG. 2. In the first embodiment shown in FIG. 1 and FIG. 2, the structure is such that the donut-shaped cylinder part 203 constituted by an elastic member is sandwiched by the outer ring 202 and the inner hub 204 in the radial direction. On the other hand, in the present embodiment, the power transmission device 20 comprises a plate 205 and the plate 205 is arranged so as to come into contact with the outer surface of the front end side of the rotating shaft of the hub 2, as can be seen from FIG. 16, and the structure is such that the outer ring 202 is bent into an L-shape and thereby, the donut-shaped cylinder part 203 constituted by an elastic member is sandwiched by the plate 205 and the outer ring 202 in the axial direction. Injection holes 206 (four in the present embodiment, however, another number may be used) are provided in the plate 205 and an elastic member, such as rubber, is injected from the injection holes 206 to form the cylinder part 203. The elastic member that forms the cylinder part 203 fills the injection hole 206 and further overflows outwardly to couple the plate 205 and the cylinder part 203, for example, as shown in FIG. 15 and FIG. 16. The cylinder part 203 may be installed continuously or concentrically, discretely, and partially. As in the embodiment in FIG. 1, on the outer peripheral portion of the hub 2, the elastic member (the concave/convex part) 201 having a concave/convex shape is arranged and inserted into the concave/convex part 101 of the pulley 1 to transmit power. In the concave/convex part 201, the hole 201b is provided. The eleventh embodiment discloses a structure of the hub 2 different from that in the above-mentioned first to tenth embodiments and as configurations other than those mentioned above are fundamentally the same as those in the first embodiment, an explanation is omitted.

Referring to the drawings, more particularly, to FIG. 5 to FIG. 16, the components of the power transmission device in the first embodiment disclosed in FIG. 1 to FIG. 4 are the same as or similar to the components in FIG. 5 to FIG. 16, and therefore, they are specified by the same reference symbols.

Next, the effect and function of the above-mentioned embodiments are explained below.

The following effects can be expected from the power transmission device in the first embodiment of the present invention.

In the power transmission device having a structure in which insertion is established by the pulley and the concave/convex part of the hub constituted by an elastic member, a power transmission device having a high performance damping mechanism is provided by providing a hole in the concave/convex part of the hub to reduce the torsional spring modulus of the concave/convex part of the hub and to reduce the total torsional spring modulus of the power transmission device without losing durability considerably.

Accordingly, in a power transmission device for a compressor for a vehicle air conditioner operated by an external power source, such as an engine, via a belt etc., it is possible to effectively reduce vibration and noise due to torque variation produced by the compressor, etc.

The same effects as those in the above-mentioned first embodiment can be expected from the power transmission device in the second to eighth and eleventh embodiments of the present invention.

The following effect can be expected from the power transmission device in the ninth and tenth embodiments of the present invention, in addition to the effects in the above-mentioned first embodiment.

When the power transmission shut-off member operates, there is a possibility of the concave/convex part of the hub dropping from the pulley if the cylinder part is destroyed, however, by providing a pin etc. and coupling the concave/convex part of the hub and the pulley, it is possible to prevent the concave/convex part from dropping.

In the above-mentioned embodiments, an example in which the present invention is used as a power transmission device for the compressor of an air conditioner for a vehicle is shown, however, the present invention may be applied to a use other than this and the application of the present invention is not limited to use in an air conditioner for a vehicle.

In the above description or in the embodiments shown in the accompanied drawings, the power of the drive source is explained by a configuration in which power is transmitted to the power transmission device via a belt or pulley, however, the present invention is not limited to this and for example, power may be transmitted via another mechanism such as a gear.

The numbers, dimensions, etc., of the concave/convex parts, protrusions of the concave/convex part, and holes shown in the above-mentioned embodiments are only examples and the present invention is not limited to these, and various numbers and dimensions thereof may be accepted.

The various embodiments of the embodiments described above may be combined in a possible range. Further, in the above-mentioned embodiments, the elastic member of the outer peripheral concave/convex part 201 of the hub and the cylinder part 203 may be the same or different materials.

The above-mentioned embodiments are examples of the present invention and in no case is the present invention limited by the embodiments. The invention is specified only by the items described in the claims and various embodiments, other than those mentioned above, are possible.

While the invention has been described by reference to specific embodiments chosen for the purposes of illustration, it should be apparent that numerous modifications could be made thereto, by those skilled in the art, without departing from the basic concept and scope of the invention.

1. A power transmission device comprising:
a rotatable rotary part to which a rotational drive force is transmitted from a drive source; and
a connection part that connects to the rotary part on one hand, and connecting to a rotating shaft of a device to be driven on the other hand, wherein:
the rotary part comprises a first concave/convex part arranged in a circumferential direction and the connection part comprises a second concave/convex part arranged in the circumferential direction, and the rotary part and the connection part are connected to each other by the insertion of the first concave/convex part and the second concave/convex part into each other; and
the second concave/convex part is formed by a material having elasticity and in the second concave/convex part, at least a hole or at least a cavity is formed.

2. The power transmission device as set forth in claim 1, wherein:
the connection part comprises: a power transmission shut-off member that shuts off transmission of an excessive torque between the rotary part and the rotating shaft of the device to be driven, coupled to the rotating shaft, and capable of rotating together with the rotating shaft as one body; and a hub that connects to the rotary part on one hand, and connecting to the power transmission shut-off member on the other hand; and
the second concave/convex part is provided to the hub.

3. The power transmission device as set forth in claim 2, wherein
the hub further comprises a cylinder part formed in the second concave/convex part so as to connect thereto as one body on the inner side in a radial direction and the cylinder part is formed by a material having elasticity.

4. The power transmission device as set forth in of claim 1, wherein
at least the hole or cavity formed in the second concave/convex part penetrates the second concave/convex part.

5. The power transmission device as set forth in claim 4, wherein
a coupling member is inserted into the hole or cavity and the coupling member is formed so as to couple the rotary part and the second concave/convex part.

6. The power transmission device as set forth in claim 5, wherein
the coupling member couples the rotary part and the second concave/convex part even when the cylinder part ruptures.

7. The power transmission device as set forth in claim 4, further comprising an annular plate, wherein
the annular plate is arranged on the side in opposition to the rotary part with the second concave/convex part sandwiched in between and an extension part that extends from the plate passes through the hole or cavity and connects to the rotary part.

8. The power transmission device as set forth in of claim 1, wherein connection is made to a compressor for a vehicle air conditioner as a device to be driven.
